(19) United States
(12) Patent Application Publication
(10) Pub. No.: US 2024/0036171 A1
(43) Pub. Date: Feb. 1, 2024

(54) OPTICAL APPARATUS, SYSTEM, AND MOVING APPARATUS

(71) Applicant: CANON KABUSHIKI KAISHA, Tokyo (JP)

(72) Inventor: Masatsugu NAKANO, Tochigi (JP)

(21) Appl. No.: 18/337,475

(22) Filed: Jun. 20, 2023

(30) Foreign Application Priority Data
Aug. 1, 2022 (JP) 2022-122865

(51) Int. Cl. G01S 7/481; G01S 17/931

(52) U.S. Cl. CPC G01S 7/4815; G01S 17/931

(57) ABSTRACT

An optical apparatus includes a light source unit, a deflector configured to deflect illumination light from the light source unit to scan an object, and a light receiving unit configured to receive reflected light from the object. The light source unit includes at least one light emitting unit and an optical element array including a plurality of optical elements. The optical element array separates light emitted from one light emitting unit among the at least one light emitting unit into two or more illumination lights that enter the deflector at angles different from each other.

### BACKGROUND

### Technical Field

One of the aspects of the embodiments relates to an optical apparatus for detecting a target (object) or measuring a distance to the target by receiving reflected light from the illuminated target.

### Description of Related Art

A method for measuring the distance to the target includes LiDAR (Light Detection and Ranging) which calculates the distance from the time from when the target is irradiated with illumination light to when the reflected light from the target is received or a phase of the reflected light. A vertical cavity surface emitting laser (VCSEL) is a high-output light source for LiDAR.

Japanese Patent Laid-Open No. 2019-159067 discloses an optical apparatus that includes a light source having a plurality of surface emitting lasers, a scanner that scans an object with laser light from the light source, a lens array located between the light source and the scanner, and another optical element. US Patent Application Publication No. 2015-0340841 discloses an optical apparatus that includes a laser array including a plurality of lasers and a lens array including a plurality of lenses, and irradiates a target with illumination light from each laser through a corresponding lens.

However, in a case where each surface emitting laser and a lens of the lens array have a one-to-one correspondence, part of the divergent light from the surface emitting laser may enter the lens adjacent to the corresponding lens, and the light utilization efficiency lowers. Japanese Patent Laid-Open No. 2019-159067 uses the optical element different from the lens array so as to solve this problem, and causes the optical apparatus to increase its size. US Patent Application Publication No. 2015-0340841 has no scanner, unlike Japanese Patent Laid-Open No. 2019-159067, and thus requires many surface emitting lasers to irradiate illumination light over a wide angle of view (view field).

### SUMMARY

An optical apparatus according to one aspect of the disclosure includes a light source unit, a deflector configured to deflect illumination light from the light source unit to scan an object, and a light receiving unit configured to receive reflected light from the object. The light source unit includes at least one light emitting unit and an optical element array including a plurality of optical elements. The optical element array separates light emitted from one light emitting unit among the at least one light emitting unit into two or more illumination lights that enter the deflector at angles different from each other. A system and a moving apparatus each having the above optical apparatus also constitute another aspect of the disclosure.

Further features of the disclosure will become apparent from the following description of embodiments with reference to the attached drawings.

### BRIEF DESCRIPTION OF THE DRAWINGS

FIG. 1 illustrates the configuration of an optical apparatus according to Example 1.

FIGS. 2A and 2B are optical path diagrams of illumination light and reflected light according to Example 1.

FIGS. 3A, 3B, and 3C illustrate the configuration of a light source unit according to Example 1.

FIGS. 4A and 4B illustrate the configuration of a light source unit according to a variation of Example 1.

FIGS. 5A, 5B, and 5C illustrate the configuration of an optical apparatus according to Example 2.

FIGS. 6A and 6B illustrate the configuration of an optical apparatus according to Example 3.

FIGS. 7A, 7B, and 7C illustrate the configuration of a light source unit according to Example 3.

FIG. 8 illustrates the configuration of an optical apparatus according to Example 4.

FIGS. 9A, 9B, and 9C illustrate scanning patterns of the optical apparatuses according to Examples 1 to 3.

FIG. 10 is a block diagram illustrating the configuration of an on-board system including the optical apparatus according to any one of Examples 1 to 3.

FIG. 11 illustrates a vehicle including the on-board system.

FIG. 12 is a flowchart illustrating the operation of the on-board system.

### DESCRIPTION OF THE EMBODIMENTS

Referring now to the accompanying drawings, a description will be given of examples according to the disclosure.

The optical apparatus according to each example is used for LiDAR, and includes an illumination system that illuminates a target (object) and a light receiving system configured to receive reflected light and scattered light from the target. LiDAR is classified into a coaxial system in which the optical axes of the illumination system and the light receiving system partially coincide with each other, and a noncoaxial system in which the respective optical axes do not coincide with each other. The optical apparatus according to each example can be used for both the coaxial and noncoaxial LiDAR.

The optical apparatus according to each example is used, for example, in an on-board system (in-vehicle system) such as an automatic driving support system mounted on a vehicle such as an automobile. The target includes a pedestrian, an obstacle, a vehicle, etc., and is located at a distance of about 1 to 300 m. The optical apparatus according to each example measures a distance to the target, and controls the direction and speed of the vehicle based on the measurement result.

### EXAMPLE 1

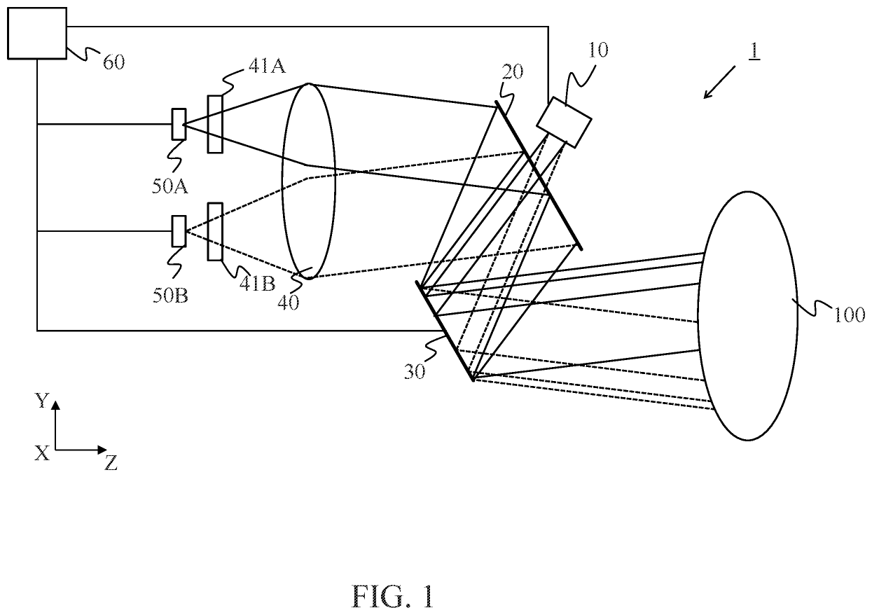

FIG. 1 illustrates the configuration of an optical apparatus 1 according to Example 1 of the present disclosure. FIG. 1 illustrates a section (YZ section) including an optical axis of the optical apparatus 1.

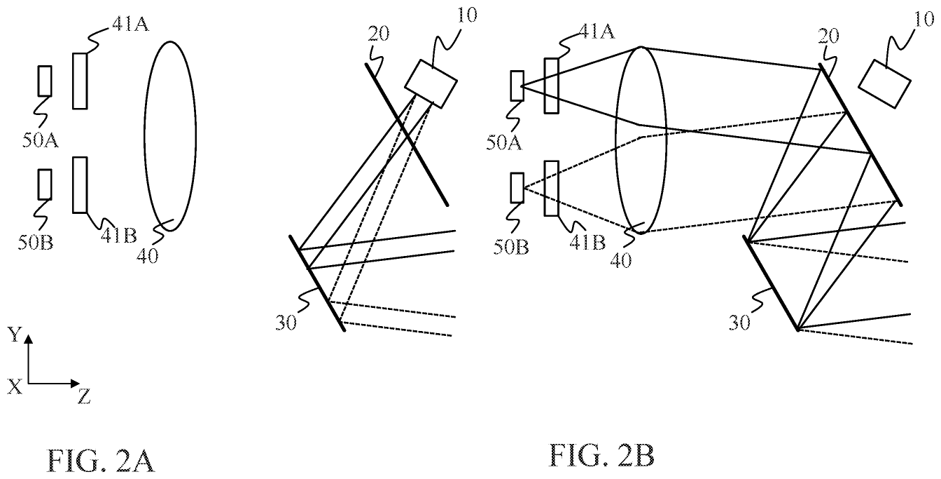

The optical apparatus 1 includes a light source unit 10, a first optical system 20, a deflector 30, a second optical system 40, optical filters 41A and 41B, light receiving units 50A and 50B, and a control unit 60. FIG. 2A illustrates an optical path of illumination light in a case where the illumination light from the light source unit 10 in the optical apparatus 1 goes to a target 100. FIG. 2B illustrates an optical path of received light in a case where reflected light from the target 100 goes to the light receiving units 50A and 50B.

The optical apparatus 1 acquires distance information to the target 100 by irradiating the target 100 with illumination light and by receiving reflected light from the target 100. More specifically, the optical apparatus 1 calculates the distance to the target 100 based on the time from when the target 100 is irradiated with the illumination light to when the reflected light from the target 100 is received and a phase of the reflected light. An optical apparatus having the same configuration as that of the optical apparatus 1 can also be used as an image pickup apparatus that detects and images the target 100.

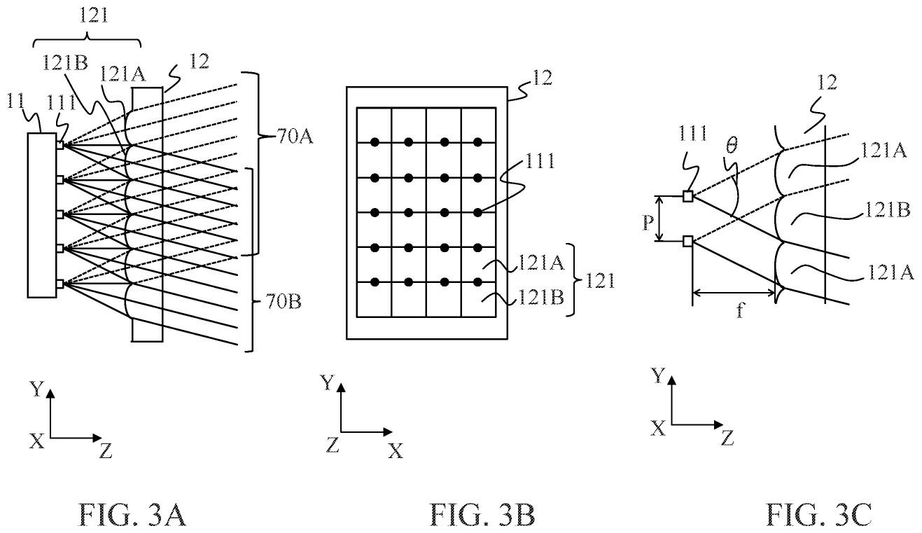

FIG. 3A illustrates the yz section of the light source unit 10 in the optical apparatus according to this example. FIG. 3B illustrates the light source unit 10 viewed from the z direction. FIG. 3C illustrates an enlarged part of FIG. 3A.

A light source unit 10 includes a light source 11 and an optical element array 12 arranged in the z direction. The light source 11 includes a plurality of light emitting units (light emitting elements) 111. Each light emitting unit 111 can use a semiconductor laser with high energy concentration and high directivity, such as a vertical resonator type surface emitting laser or VC SEL. Since the target 100 in the on-board system includes a human, a light emitting unit 111 that emits infrared light, for example, light with a wavelength of 940 nm in the near-infrared region that has insignificant effect on human eyes is used. Although this example has 4×5 light emitting units 111, the number of light emitting units is not limited to this example.

The optical element array 12 includes a plurality of lenses 121 which are a plurality of optical elements each having optical power, and has a function of changing the convergence degree of illumination light emitted from each light emitting unit 111. More specifically, the optical element array 12 is a collimator lens (condensing element) that converts (collimates) divergent light beams from the light emitting units 111 into parallel light beams. The parallel light beam includes not only strictly parallel light beam but also light beam that can be regarded as a parallel light beam, such as a slightly diverging light beam and a slightly converging light beam.

The optical element array 12 includes two lenses 121 (121A, 121B) adjacent in the y direction for each light emitting unit 111 so as to contact each other at a boundary extending in the x direction. The two lenses 121 corresponding to each light emitting unit 111 are eccentric relative to the light emitting unit 111, and each light emitting unit 111 is located above the boundary between the two corresponding lenses 121 (above a position corresponding to the boundary between the lenses 121). That is, the center of each light emitting unit 111 is located at a position that shifts from the position on the optical axis of each of the two lenses 121 corresponding to the light emitting unit 111. Thereby, the light emitted from the light emitting unit 111 enters two corresponding lenses 121 as illustrated in FIGS. 3A and 3C.

Among the divergent light beams emitted from each light emitting units 111, light traveling in the +y direction as indicated by dashed lines passes through the lenses 121 disposed in the +y direction from the light emitting units 111 and becomes first illumination light 70A. On the other hand, as indicated by solid lines, light traveling in the −y direction passes through the lenses 121 arranged in the −y direction from the light emitting units 111 and becomes second illumination light 70B that travels at an angle different from that of the first illumination light 70A. Thus, the light from the light emitting unit 111 enters the two adjacent lenses 121 and is separated into the first and second illumination lights 70A and 70B that enter the deflector 30 described below at different angles (in traveling directions different from each other). At this time, the lens 121 which the light traveling in the −y direction from one of the two adjacent light emitting units 111 enters also receives the light traveling in the +y direction from the other light emitting unit. That is, three lenses 121 are provided for two adjacent light emitting units 111, and one central lens among the three lenses 121 is shared by the two light emitting units 111. Thereby, the light source 11 can become smaller than that in a case where each light emitting unit 111 is provided to two corresponding lenses because a distance between adjacent light emitting units 111 can be reduced. The optical element array 12 can become smaller by reducing the number of lenses 121 provided to all the light emitting units 111.

In this example, the two lenses 121 (121A, 121B) provided for each light emitting unit 111 are eccentric in opposite directions (±y directions) with respect to the center of the light emitting unit. This lens arrangement can increase a separating angle difference between the first illumination light 70A and the second illumination light 70B, and can widen illumination ranges (angles of views and fields) of the first illumination light 70A and the second illumination light 70B.

Each of the light emitting units 111 and the lenses 121 may be arranged at regular intervals in the separating direction of the illumination light. This arrangement can reduce a light amount loss in the optical element array 12 in the light from the light emitting unit 111. The following inequality may be satisfied:

P≥f×tan(θ/2) (1)

where P is an arrangement interval (distance), f is a focal length of each lens 121, and θ is a divergent angle of light from each light emitting unit 111.

Satisfying inequality (1) enables the divergent light emitted from each light emitting unit 111 to exclusively enter the corresponding two lenses 121, and can further reduce the light amount loss.

The first optical system 20 illustrated in FIG. 1 guides the illumination light from the light source unit 10 to the deflector 30, and directs the reflected light from the deflector 30 to the light receiving units 50A and 50B via the second optical system 40 and the optical filters 41A and 41B. The first illumination light 70A and the second illumination light 70B from the light source unit 10 pass through the transmission area of the first optical system 20, enter the deflector 30, are reflected by the deflector 30, and illuminate the target 100 within the view field. On the other hand, the reflected light from the target 100 is reflected by the deflector 30, is further reflected by the reflective area of the first optical system 20, and enters the light receiving units 50A and 50B via the optical filters 41A and 41B. The reflective area of the first optical system 20 is provided by forming a reflective film made of metal, dielectric, or the like on a lens surface as a substrate. Although FIG. 1 illustrates the case where the first optical system 20 includes one lens, it may include a plurality of lenses.

The deflector 30 includes a single movable mirror, deflects the illumination light from the first optical system 20 to scan the target 100 within the view field, and deflects the reflected light from the target 100 to the first optical system 20. In order to enable two-dimensional scanning of the target 100, the movable mirror includes a Galvano mirror, a MEMS (Micro Electro Mechanical System) mirror, or the like that can swing about at least two swing axes orthogonal to each other. This example uses as the movable mirror, for example, a MEMS mirror having a swing angle of ±5° around the X-axis, a swing angle of ±15° around the Y-axis, and a swing frequency of about 1 kHz.

The first illumination light 70A and the second illumination light 70B enter the deflector 30 at different angles from the first optical system 20. Thereby, different fields in the Y direction can be scanned at the same time, and a field at a wider angle can be scanned than that in a case where one illumination light is incident on the deflector 30.

The second optical system 40 collects the reflected light from the first optical system 20 on the light receiving surfaces of the light receiving units 50A and 50B. The optical filters 41A and 41B transmit only the light to be received by the light receiving units 50A and 50B among the reflected light from the first optical system and shield (absorb) other unnecessary light. In this example, the optical filters 41A and 41B include bandpass filters that transmit only the light of the wavelength corresponding to the illumination light from the light source unit 10 out of the reflected light from the target 100. The arrangement of the second optical system and the optical filters 41A and 41B is not limited and any one of them may be located on the first optical system side.

The light receiving units 50A and 50B receive the reflected light that has passed through the optical filters 41A and 41B, photoelectrically convert it, and output signals. The light receiving units 50A and 50B can use PDs (Photo Diodes), APDs (Avalanche Photo Diodes), SPADs (Single Photon Avalanche Diodes), or the like. The reflected light from the target 100 illuminated by the illumination light is deflected by the deflector 30, is reflected by the reflecting area of the first optical system 20, is condensed by the second optical system 40, passes through the optical filters 41A and 41B, and reaches the light receiving units 50A, 50B.

The control unit 60 controls the light source unit 10, the deflector 30, and the light receiving units 50A and 50B. The control unit 60 is, for example, a computer including a processor such as a CPU (Central Processing Unit) and a calculation circuit. The control unit 60 drives the light source unit 10 and the deflector 30 with a predetermined driving voltage and a predetermined driving frequency. The control unit 60 controls the light source unit 10 to convert the illumination light into pulsed light, or performs intensity modulation of the illumination light to generate signal light. Based on the time from when the illumination light is emitted from the light source unit 10 (light emission time) to when the light receiving units 50A and 50B receive the reflected light from the target 100 (light receiving time), the control unit 60 acquires distance information to the target 100. At this time, the control unit 60 may acquire signals from the light receiving units 50A and 50B at a specific frequency. The control unit 60 may acquire the distance information based on the phase of the reflected light from the target 100 instead of the time until the reflected light from the target 100 is received. More specifically, the control unit 60 may calculate a difference (phase difference) between the phase of the signal of the light source unit 10 and the phase of the signals output from the light receiving units 50A and 50B, and acquire the distance information to the target 100 by multiplying the phase difference by the light speed.

The thus-configured optical apparatus 1 can realize compact coaxial LiDAR by providing the first optical system 20.

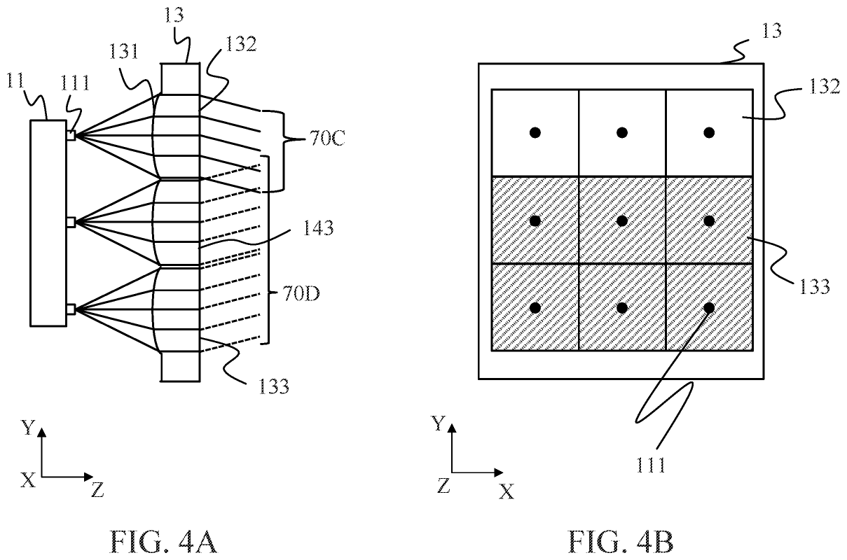

FIG. 4A illustrates a yz section of a variation of a light source unit 10, and FIG. 4B illustrates the variation viewed from the z direction. In this variation, an optical element array 13 includes a lens portion 131 having a plurality of optical powers on a surface on the light source side and has a function of collimating the illumination light emitted from the plurality of light emitting units 111 of the light source 11. The optical element array 13 includes two diffractive portions (diffractive elements) 132 and 133 as optical elements on the surface opposite to the light source side. In FIG. 4B, the diffractive portion 133 hatched.

The diffractive portions 132 and 133 diffract the illumination light in opposite directions. That is, first illumination light 70C collimated by the lens portion 131 and incident on the diffractive portion 132 is diffracted by the diffraction grating of the diffractive portion 132 in the −y direction in FIG. 4A. On the other hand, second illumination light 70D collimated by the lens portion 131 and incident on the diffractive portion 133 is diffracted by the diffraction grating of the diffractive portion 133 in the +y direction in FIG. 4A.

Thus independently controlling the diffraction directions of the illumination light by the diffractive portions 132 and 133 can expand the view field. This variation can adjust a light amount by making the areas of the diffractive portions 132 and 133 different from each other. For example, the LiDAR attached to a fixed point such as a utility pole can reduce an illumination light amount for a short distance corresponding to the lower side of the view field, and increase the illumination light amount for a long distance corresponding to the upper side of the view field. Thereby, this variation can efficiently use the illumination light amount.

In this variation, each of the plurality of light emitting units (a first light emitting unit and a second light emitting unit) 111 and the plurality of diffractive portions (a first diffractive element and a second diffractive element) 132 and 133 corresponding the light emitting units are arranged at regular intervals (equal pitches) in the separating direction (y direction) of the first and second illumination lights 70C and 70D. In this case, the following inequality (2) may be satisfied:

P≥2×f×tan(θ/2) (2)

where P is an arrangement interval (distance) between adjacent light emitting units 111 in the y direction, f is a focal length of each diffractive element, and θ is a divergent angle of light emitted from each light emitting unit 111.

Satisfying inequality (2) enables the light from the plurality of light emitting units 111 to enter only the diffractive portions 132 and 133 to which they originally enter, and can reduce the light amount loss. This variation provides the lens unit 131 on the light incident side (one side) of the optical element array 13, and the diffractive portions 132 and 132 on the light exit side (the other side), but may provide the diffractive portion may on the light incident side and the lens on the light exit side.

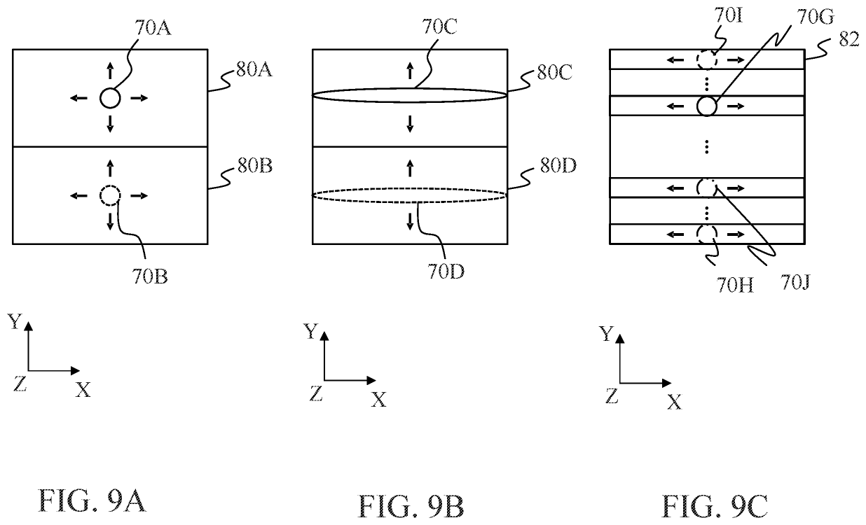

FIG. 9A illustrates scanning patterns of the illumination lights of the optical apparatus 1 according to this example (and variation). As described above, the first illumination light 70A (70C) and the second illumination light 70B (70D) are two-dimensionally scanned within view fields (illumination areas) 80A and 80B by the movable mirrors in the deflector 30 that swings about two swing axes orthogonal to each other. In this example, the separating direction of the first illumination light and the second illumination light 70B is the y direction, and the y direction is orthogonal to one of the two swing axes of the movable mirror of the deflector 30. Thereby, the view field in the y direction can be twice as large as that in a case where the illumination light is not separated.

This example is directed to an optical apparatus of a coaxial optical system, and can overlap the optical path for the illumination light and the optical path for the reflected light each other between the first optical system 20 and the deflector thereby reducing the size of the apparatus. The second optical system 40 serve to condense both the reflected light corresponding to the first illumination light 70A and the reflected light corresponding to the second illumination light 70B toward the light receiving units 50A and 50B. Using the second optical system 40 in common for the two reflected lights in this manner can simplify the configuration of the optical apparatus and reduce the number of elements.

This example can improve the light utilization efficiency from the light source and provide an optical apparatus having a wider view field.

In this example, the light from each light emitting unit is separated into two to generate the first and second illumination lights, but the number of light separations from each light emitting unit (or the number of illumination lights) may be three or more. In this case, the light from each light emitting unit enters three or more optical elements, and the center of the light emitting unit is disposed at a position that shifts from the position on the optical axis of each of the three or more optical elements. This is similarly applicable to other examples described below.

In this example, when viewed in the z-direction, the optical axes of the lenses adjacent to each other in the y-direction in the optical element array are disposed symmetrically with respect to the center of the light emitting unit that emits light that enters these lenses. However, the optical axes of adjacent lenses may be disposed asymmetrically with respect to the center of the light emitting unit, so that the angles of the first and second illumination lights incident on the deflector 30 can be adjusted. This is similarly applicable to other examples described below.

### EXAMPLE 2

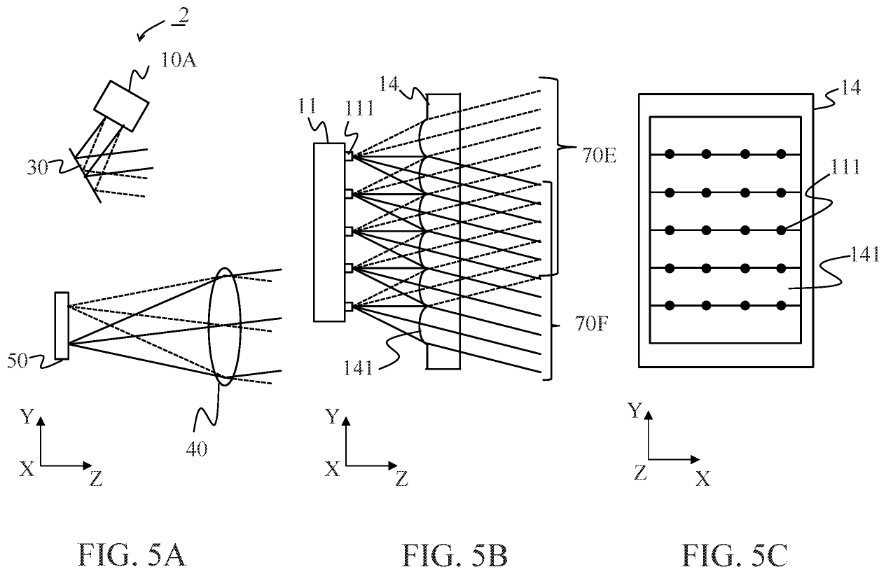

FIG. 5A illustrates the configuration of an optical apparatus 2 according to Example 2 of the present disclosure. FIG. 5B illustrates a yz section of a light source unit 10A in the optical apparatus 2. FIG. 5C illustrates the light source unit 10A viewed from the z direction. FIG. 9B illustrates a scanning pattern of the illumination light in the optical apparatus 2 according to Example 2. The optical apparatus 2 according to this example constitutes noncoaxial LiDAR in which the optical axis of the light source unit 10 and the optical axis of the second optical system 40 do not coincide with each other.

The light source unit 10A includes an optical element array 14 with a different configuration from that of the optical element array 12 according to Example 1. The optical element array 14 includes as optical elements a plurality of cylindrical lenses 141 each having optical power in the y direction (first direction), which is the illumination light separating direction, and does not have optical power in the x direction (second direction) orthogonal to the illumination light separating direction. The optical element having optical power only in one direction is not limited to a cylindrical lens, and may be another optical element such as a diffractive element.

Even in this example, as illustrated in FIG. 5B, two cylindrical lenses 141 adjacent in the y direction are provided for each light emitting unit 111 so that these lenses contact each other at the boundary extending in the x direction. The two cylindrical lenses 141 corresponding to four light emitting units 111 disposed in the x direction are eccentric with respect to the light emitting units 111 in the y direction. In the z-directional view illustrated in FIG. 5C, the four light emitting units 111 are disposed on the boundary line between the corresponding two cylindrical lenses 141. That is, the center of each light emitting unit 111 is disposed at a position that shifts from the position on the optical axis of each of the two corresponding cylindrical lenses 141. Thereby, the light emitted from the light emitting unit 111 enters two corresponding cylindrical lenses 141 as illustrated in FIG. 5B.

Among the divergent light emitted from the light emitting unit 111, the light traveling in the +y direction as indicated by a dashed line passes through the cylindrical lens 141 disposed in the +y direction from the light emitting unit 111 and is collimated to form first illumination light 70E. On the other hand, as indicated by a solid line, the light traveling in the −y direction passes through the cylindrical lenses 141 arranged in the −y direction from the light emitting unit 111 and is collimated to form second illumination light 70F that travels at an angle different from that of the first illumination light 70E. Thus, the light from the light emitting unit 111 enters the two adjacent cylindrical lenses 141 and is separated into the first and second illumination lights 70E and 70F having different traveling angles. At this time, the cylindrical lens 141 which the light from one of the two adjacent light emitting units 111 in the −y direction enters also receives the light in the +y direction from the other light emitting unit. That is, three cylindrical lenses 141 are provided to two adjacent light emitting units 111, and one central cylindrical lens among the three cylindrical lenses 141 is shared by the two light emitting units 111. Thereby, similarly to Example 1, the light source 11 and the optical element array 14 can be made smaller.

In the separating direction of the first and second illumination lights 70E and 70F, the first and second illumination lights 70E and 70F are deflected by swinging the movable mirror of the deflector 30 around the x-axis. Thereby, a wide view field corresponding to each of the first and second illumination lights 70E, 70F is scanned. On the other hand, in the direction in which the cylindrical lens 141 has no optical power, the illumination light is emitted from the optical element array 14 as divergent light without being collimated. That is, since the cylindrical lens 141 obtains illumination light that widens in the direction in which the cylindrical lens 141 has no optical power, the deflector 30 is not scanned. In general, it is easier to miniaturize a mirror that can deflect only about one axis than a mirror that can deflect about two axes, and this configuration can make smaller the optical apparatus.

Since the optical apparatus 1A according to this example is a noncoaxial system, no light amount loss occurs in a case where the optical path for the illumination light and the optical path for the reflected light are separated unlike the coaxial system, so a longer distance can be measured.

### EXAMPLE 3

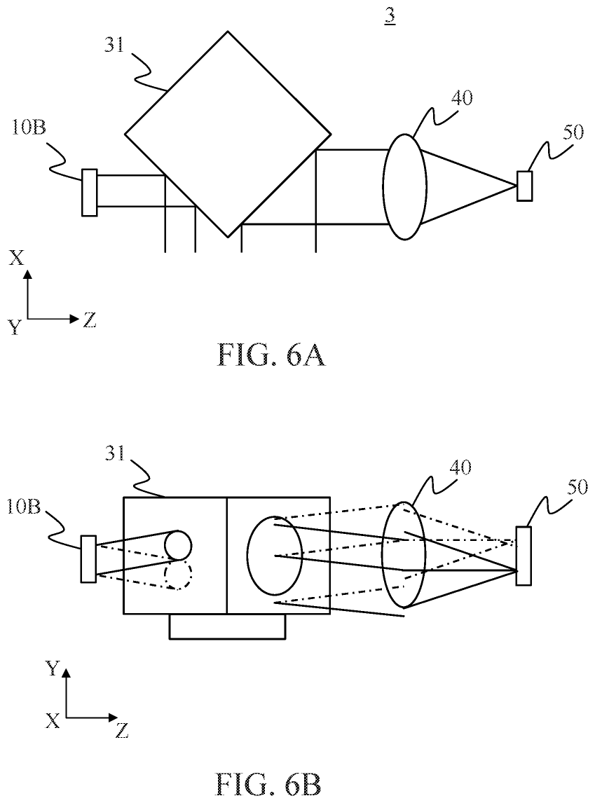

FIG. 6A illustrates an XZ section of an optical apparatus 3 according to Example 3 of the present disclosure. FIG. 6B illustrates a YZ section of the optical apparatus 3. The optical apparatus 3 according to this example constitutes noncoaxial LiDAR in which the optical axis of a light source unit 10B and the optical axis of the second optical system 40 do not coincide with each other.

Both the first illumination light (indicated by a solid line) and the second illumination light (indicated by an alternate long and short dash line) from the light source unit 10B enter the deflector 31 that is rotationally drivable. The deflector 31 is a polygon mirror having four reflective surfaces, and each reflective surface reflects the first and second illumination lights to irradiate the target. Reflected light from the target irradiated with the illumination light is reflected by a surface of the polygon mirror different from the surface on which the first and second illumination lights are reflected, and is guided to the second optical system 40. The second optical system 40 collects the incident reflected light toward the light receiving unit

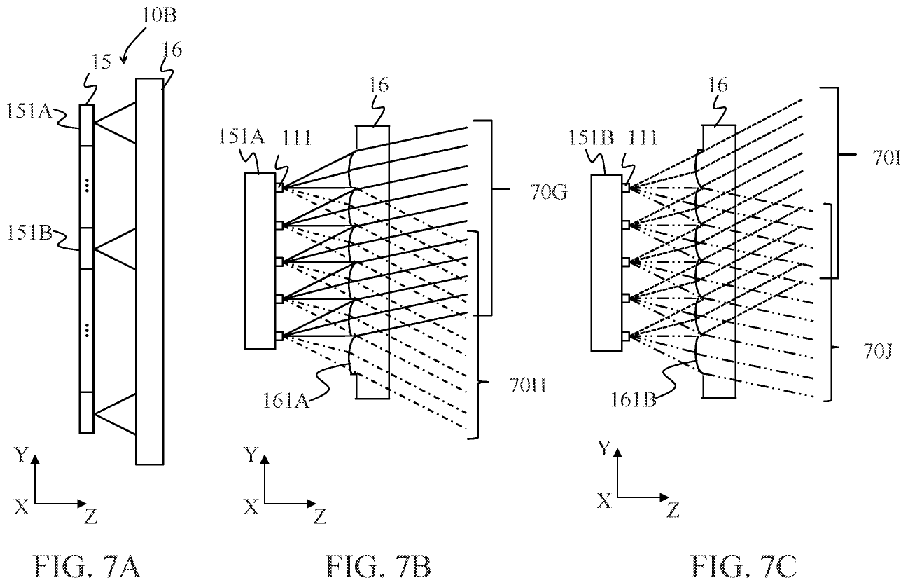

FIG. 7A illustrates the yz section of the light source unit 10B. The light source unit 10B includes a light source 15 and an optical element array 16. The light source 15 includes a plurality of light emitting unit groups in which a plurality of light emitting units (indicated by reference numeral 111 in FIGS. 7B and 7C) are disposed in one area. In the following description, a first light emitting unit group 151A and a second light emitting unit group 151B as two light emitting unit groups will be described.

FIG. 7B illustrates the yz section of the first light emitting unit group 151A and the corresponding first optical element group (first lens array unit) of the optical element array 16 corresponding to the first light emitting unit group 151A. Illumination light emitted from the first light emitting unit group 151A enters a first lens array unit including lenses 161A as a plurality of optical elements each having an optical power. Each lens 161A has a function of changing the convergence degree of illumination light. Each lens 161A is an eccentric lens in which the vertex of the lens surface shifts (decentered) from the center of the lens surface. Even in this example, two lenses 161A adjacent in the y direction so that they contact each other at the boundary extending in the x direction are provided for each light emitting unit 111. Each light emitting unit 111 is disposed on the boundary line between the two lenses 161A corresponding to that light emitting unit 111 when viewed in the z direction. That is, the center of each light emitting unit 111 is disposed at a position that shifts from the position on the optical axis of each of the two corresponding lenses 161A.

Thereby, among the divergent light emitted from the light emitting unit 111, the light traveling in the +y direction as indicated by a solid line passes through the lens 161A disposed in the +y direction from the light emitting unit 111 and becomes first illumination light 70G. Among the divergent light emitted from the light emitting unit 111, the light traveling in the -y direction as indicated by an alternate long and short dash line passes through the lenses 161A arranged in the −y direction from the light emitting unit 111 and becomes second illumination light 70H. Thus, light emitted from each light emitting unit 111 enters two corresponding lenses 161A and is separated into the first illumination light 70G and the second illumination light 70H. Changing the eccentricity of the lens 161A can adjust the traveling angles of the first and second illumination lights 70G and 70H.

FIG. 7C illustrates the yz section of the second light emitting unit group 151B and the second optical element group (second lens array unit) of the optical element array 16 corresponding to the second light emitting unit group 151B. Illumination light emitted from the second light emitting unit group 151B enters a second lens array unit including the lenses 161B as a plurality of optical elements each having optical power. Each lens 161B has a function of changing the convergence degree of illumination light. Each lens 161B is a decentered lens in which the vertex of the lens surface shifts from the center of the lens surface, and has an eccentric amount (that is, an offset amount of the optical axis from the center of the light emitting unit) different from that of the lens 161A. The two lenses 161B adjacent to each other in the y direction so that they contact each other at the boundary extending in the x direction are provided for each light emitting unit 111, and each light emitting unit 111 is disposed on the boundary line between the two lenses 161B corresponding to that light emitting unit 111 when viewed in the z direction. That is, the center of each light emitting unit 111 is disposed at a position that shifts from the optical axis center of each of the two corresponding lenses 161B.

Thereby, among the divergent light emitted from the light emitting unit 111, the light traveling in the +y direction as indicated by a solid line passes through the lenses 161B arranged in the +y direction from the light emitting unit 111 and becomes first illumination light 701. Among the divergent light emitted from the light emitting unit 111, the light traveling in the −y direction as indicated by an alternate long and two short dashes line passes through the lenses 161B arranged in the −y direction from the light emitting unit 111 and becomes second illumination light 70J. Thus, light emitted from each light emitting unit 111 enters two corresponding lenses 161B and is separated into the first illumination light 701 and the second illumination light 70J. Changing an eccentric amount of the lens 161B can adjust the traveling angles of the first and second illumination lights 70G and 70H.

In this example, the advancing angles of the first and second illumination lights 701 and 70J and the separation angles, which are the differences therebetween, are different from the advancing angles and the separation angles of the first and second illumination lights 70G and 70H.

FIG. 9C illustrates a scanning pattern of the illumination light in the optical apparatus 3 according to this example. The illumination lights 70G to 70J are one-dimensionally scanned by the deflector 30 to irradiate different field areas of an overall view field 82. Similarly, as to light emitting unit groups other than the first and second light emitting unit groups 151A and 151B in the light source 15, the illumination light enters the other lens array portion in the optical element array 16 and is separated, and is irradiated onto a view field area other than the view field area onto which the illumination lights 70G to 70J are irradiated. Thereby, the overall view field 82 is thoroughly scanned.

This example can secure a wide view field while reducing the illumination light amount loss.

### EXAMPLE 4

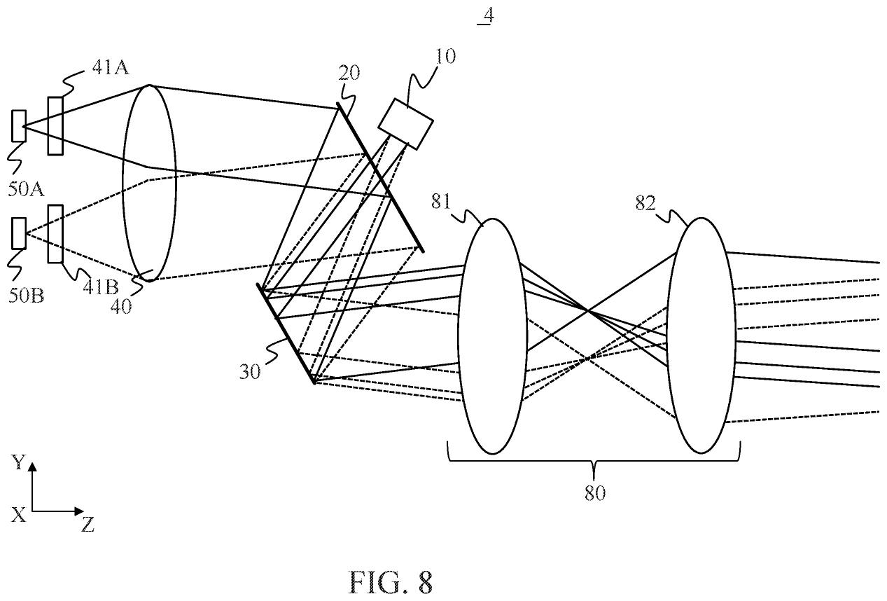

FIG. 8 illustrates a YZ section of an optical apparatus 4 according to Example 4 of the present disclosure. Unlike the optical apparatus 1 according to Example 1, the optical apparatus 4 according to this example includes a third optical system 80 disposed between the deflector 30 and a target (not illustrated). Other configurations are similar to those of the optical apparatus 1 according to Example 1.

The third optical system 80 is a telescope optical system that expands the diameter of the illumination light from the deflector 30 and reduces the diameter of the reflected light from the target. The third optical system 80 includes a plurality of optical elements (lenses) each having refractive power, and is an afocal system having no refractive power as a whole system. More specifically, the third optical system 80 includes, in order from the deflector side toward the target, a first lens 81 having positive power and a second lens 82 having positive power. The configuration of the third optical system 80 is not limited to this example, and may include three or more lenses.

In this example, the deflector 30 is disposed at the entrance pupil position of the third optical system 80. The absolute value of the optical magnification (lateral magnification) β of the third optical system 80 is larger than 1 (|β|>1). Thereby, the deflection angle of the principal ray of the illumination light emitted from the third optical system 80 becomes smaller than that of the principal ray of the illumination light that is deflected by the deflector 30 and then enters the third optical system 80, and the resolution can be improved in detecting the target.

The first and second illumination lights from the light source unit 10 are deflected by the deflector 30 through the first optical system 20, magnified by the third optical system 80 according to the optical magnification β, and irradiated onto the target. Reflected light from the target is reduced by the third optical system 80 according to its optical magnification 1/β, is deflected by the deflector 30, is condensed by the second optical system 40, and reaches the light receiving units and 50B.

Thus disposing the third optical system 80 on the target side of the deflector can enlarge the diameter of the illumination light by the third optical system 80. Thereby, this example can further increase the diameter of the illumination light, reduce the spread angle of the illumination light, and secure sufficient illuminance and resolution even in a case where the target is located at a distant place. Enlarging the pupil diameter with the third optical system 80 can take in more reflected light from the target, and improve the measuring distance and the measuring accuracy.

### On-Board System (In-Vehicle System)

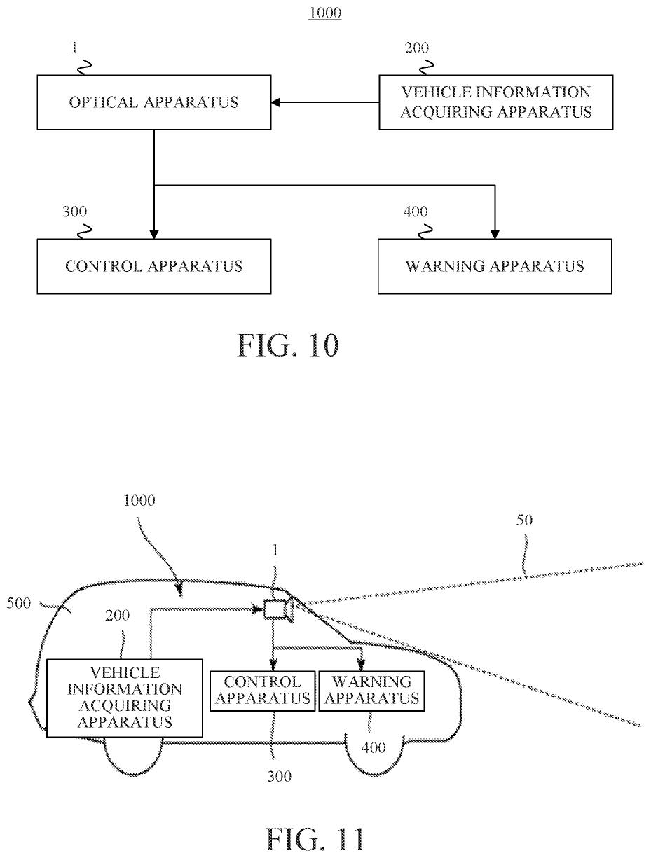

FIG. 10 illustrates the configuration of an on-board system 1000 as a driving support apparatus including any one of the optical apparatuses 1 to 4 (although which is indicated as optical apparatus 1 in FIG. 10) according to Examples 1 to 3.

The on-board system 1000 is an apparatus held by a moving apparatus such as an automobile (vehicle), and configured to assist the user in driving (steering) the vehicle based on distance information to the target such as an obstacle and a pedestrian around the vehicle acquired by the optical apparatus 1.

FIG. 11 schematically illustrates a vehicle 500 including an on-board system 1000. In FIG. 11, the distance measuring range (detection range) of the optical apparatus 1 is set in front of the vehicle 500, but the distance measuring range may be set in the rear or side of the vehicle 500, for example.

As illustrated in FIG. 11, the on-board system 1000 includes the optical apparatus 1, a vehicle information acquiring apparatus 200, a control apparatus (ECU: electronic control unit) 300, and a warning apparatus (warning unit) 400. In the on-board system 1000, the control unit 60 provided in the optical apparatus 1 has functions as a distance acquiring unit and a collision determining unit. However, if necessary, the on-board system 1000 may include the distance acquiring unit and the collision determining unit separate from the control unit 60, and each may be provided outside the optical apparatus 1 (for example, inside the vehicle 500). Alternatively, the control apparatus 300 may be used as the control unit 60.

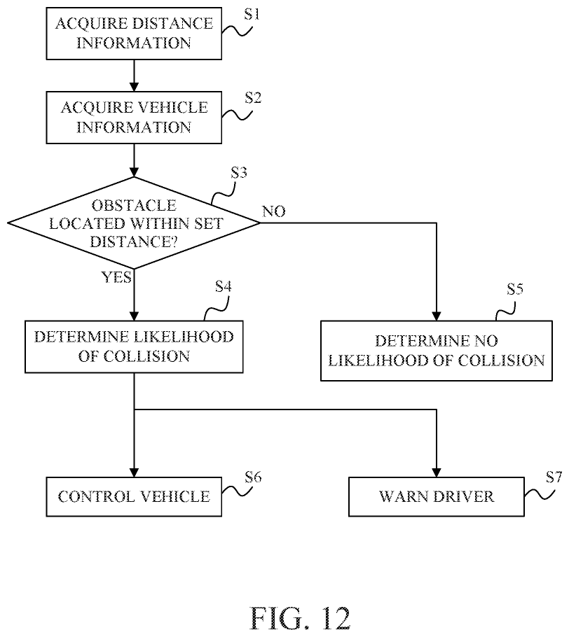

FIG. 12 is a flowchart illustrating an illustrative operation of the on-board system 1000 according to this example. The operation of the on-board system 1000 will be described below along this flowchart.

First, in step S1, a target around the vehicle is illuminated by the light source unit 10 of the optical apparatus 1, and light reflected from the target is received, and the control unit 60 acquires distance information to the target based on the signal output from the light receiving element 52.

In step S2, the vehicle information acquiring apparatus 200 acquires vehicle information including the vehicle speed, yaw rate, steering angle, and the like.

In step S3, the control unit 60 determines whether or not the distance to the target is within the preset distance range using the distance information acquired in step S1 and the vehicle information acquired in step S2.

Thereby, the control unit 60 can determine whether or not the target exists within a set distance around the vehicle, and can determine the likelihood of collision between the vehicle and the object. Steps S1 and S2 may be performed in the order opposite to the order described above, or may be performed in parallel. The control unit 60 determines that there is the “likelihood of collision” in a case where the target exists within the set distance (step S4), and determines that there is no likelihood of collision in a case where the target does not exist within the set distance (step S5).

In a case where the control unit 60 determines that there is the likelihood of collision, the control unit 60 notifies (transmits) the determination result to the control apparatus 300 and the warning apparatus 400. At this time, the control apparatus 300 controls the vehicle based on the determination result of the control unit 60 (step S6), and the warning apparatus 400 warns the user (driver) of the vehicle based on the determination result of the control unit 60 (step S7). The determination result may be notified to at least one of the control apparatus 300 and the warning apparatus 400.

The control apparatus 300 can control the movement of the vehicle by outputting a control signal to a driving unit (engine, motor, etc.) of the vehicle. For example, the control apparatus 300 performs control such as applying a brake in a vehicle, releasing an accelerator, turning a steering wheel, generating a control signal for generating a braking force in each wheel, and suppressing the output of an engine or a motor. The warning apparatus 400 warns the driver, for example, by emitting a warning sound, displaying warning information on the screen of the car navigation system, vibrating the seat belt or steering wheel, or the like. The on-board system 1000 described above can detect the target, measure the distance to the target through the above processing, and avoid collision between the vehicle and the target. In particular, applying the optical apparatus 1 according to each of the above examples to the on-board system 1000 can achieve high distance measuring accuracy, and thus can detect a target and detect collisions with high accuracy.

In this example, the on-board system 1000 is applied to driving support (collision damage reduction), but the on-board system 1000 can be applied to cruise control (including adaptive cruise control function), automatic driving, etc. The on-board system 1000 can be applied not only to vehicles such as automobiles, but also to various moving apparatuses such as ships, aircraft, and industrial robots. The on-board system 1000 can be applied not only to moving apparatuses but also to various apparatuses that use object recognition, such as intelligent transportation systems (ITS) and monitoring systems.

The on-board system 1000 and the moving apparatus 500 may include a notification apparatus (notification unit) configured to notify the on-board system manufacturer and the moving apparatus distributor (dealer) of the fact of the collision in a case where the moving apparatus 500 collides with an obstacle. For example, the notification apparatus may transmit information (collision information) about the collision between the moving apparatus 500 and the obstacle to a preset external notification destination by e-mail or the like.

Thus, the configuration that automatically notifies the collision information through the notification apparatus can promptly respond to inspections, repairs, etc. after the collision occurs. The notification destination of the collision information is not limited to the predetermined notification destination such as an insurance company, a medical institution, and the police, and may be an arbitrary notification destination set by the user. The notification apparatus may be configured to notify the notification destination not only of the collision information but also of failure information of each part and consumption information of consumables. The presence or absence of collision may be detected using distance information acquired based on the output from the light receiving unit described above, or may be performed by another detector (sensor).

This example can provide an optical apparatus configured to irradiate a wide view field with illumination light while increasing the light utilization efficiency.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

For example, the centers of the optical axes of the adjacent lenses in the optical element array may not be symmetrical with respect to the light emitting unit unlike the above example. In addition, since the center position of the optical axis differs for each lens, the light can enter the deflector 30 at various angles.

This application claims the benefit of Japanese Patent Application No. 2022-122865, filed on Aug. 1, 2022, which is hereby incorporated by reference herein in its entirety.

What is claimed is:

1. An optical apparatus comprising:
a light source unit;
a deflector configured to deflect illumination light from the light source unit to scan an object; and
a light receiving unit configured to receive reflected light from the object,
wherein the light source unit includes at least one light emitting unit and an optical element array including a plurality of optical elements, and
wherein the optical element array separates light emitted from one light emitting unit among the at least one light emitting unit into two or more illumination lights that enter the deflector at angles different from each other.

2. The optical apparatus according to claim 1, wherein the optical element array collimates the illumination light and directs it towards the deflector.

3. The optical apparatus according to claim 1,
wherein the light from the light emitting unit enters two or more optical elements, and
wherein the two or more optical elements are eccentric with respect to the one light emitting unit.

4. The optical apparatus according to claim 3, wherein two adjacent optical elements among the two or more optical elements are eccentric in opposite directions with respect to the one light emitting unit.

5. The optical apparatus according to claim 4, wherein the one light emitting unit is disposed at a position corresponding to a boundary between the two or more optical elements.

6. The optical apparatus according to claim 3, wherein light from a light emitting unit other than the one light emitting unit enters a plurality of optical elements including at least one of the two or more optical elements.

7. The optical apparatus according to claim 1,
wherein the light source unit includes two or more light emitting units, and
wherein a distance between the two or more light emitting units and a distance between the plurality of optical elements are equal to each other.

8. The optical apparatus according to claim 7, wherein the following inequality is satisfied:
P≥f×tan(θ/2)
where P is the distance, f is a focal length of the optical element, and θ is a divergent angle of the light from the light emitting unit.

9. The optical apparatus according to claim 3,
wherein the at least one light emitting unit includes a first light emitting unit and a second light emitting unit,
wherein the optical element array includes a first optical element group corresponding to the first light emitting unit and a second optical element group corresponding to the second light emitting unit, each of the first optical element group and the second optical element group including two or more optical elements, and
wherein an eccentric amount of the optical element included in the first optical element group relative to the first light emitting unit is different from an eccentric amount of the optical element included in the second optical element group relative to the second light emitting unit.

10. The optical apparatus according to claim 1, wherein the optical element includes a diffractive element.

11. The optical apparatus of claim 10,
wherein the at least one light emitting unit includes a first light emitting unit and a second light emitting unit, and
wherein a diffraction direction of the diffractive element which light from the first light emitting unit enters and a diffraction direction of another diffractive element which light from the second light emitting element enters are different from each other.

12. The optical apparatus according to claim 10, wherein the optical element array includes:
a lens portion configured to collimate the light from the light emitting unit and disposed on one of a light incident side and a light exit side; and
the diffractive element disposed on another of the light incident side and the light exit side.

13. The optical apparatus according to claim 11, wherein the following in equality is satisfied:
P≥2×f×tan(θ/2)
where P is a distance between the first light emitting unit and the second light emitting unit, f is a focal length of the diffractive element, and θ is a divergent angle of the light from the light emitting unit.

14. The optical apparatus according to claim 1, wherein the optical element has optical power only in a separating direction into the two or more illumination lights.

15. The optical apparatus according to claim 1,
wherein the deflector includes a mirror swingable around a swing axis, and
wherein a separating direction into the two illumination lights is a direction orthogonal to the swing axis.

16. A system comprising the optical apparatus according to claim 1,
wherein the system determines a likelihood of collision between a moving apparatus and the object based on distance information to the object acquired by the optical apparatus.

17. The system according to claim 16, further comprising a control apparatus configured to output a control signal for generating a braking force to the moving apparatus in a case where the control apparatus determines that there is the likelihood of collision between the moving apparatus and the object.

18. The system according to claim 16, further comprising a warning apparatus configured to warn a user of the moving apparatus in a case where it is determined that there is the likelihood of collision between the moving apparatus and the object.

19. The system according to claim 16, further comprising a notification apparatus configured to notify outside of information about collision between the moving apparatus and the object.

20. A moving apparatus comprising the optical apparatus according to claim 1,
wherein the moving apparatus is configured to hold and movable with the optical apparatus.
